(19) United States
(12) Patent Application Publication
(10) Pub. No.: US 2022/0337057 A1
(43) Pub. Date: Oct. 20, 2022

(54) Vehicle Battery Jump-Start Device

(71) Applicant: Scott Drake, Hobart, IN (US)

(72) Inventor: Scott Drake, Hobart, IN (US)

(21) Appl. No.: 17/715,232

(22) Filed: Apr. 7, 2022

Related U.S. Application Data
(60) Provisional application No. 63/175,092, filed on Apr. 15, 2021.

(51) Int. Cl. H02J 1/10; H02J 7/34; H02J 7/00

(52) U.S. Cl. CPC H02J 1/122; H02J 7/342; H02J 7/0045; H01M 50/264

(57) ABSTRACT

The present invention relates generally to the field of battery charging, jump-start or battery assist devices. More specifically, the present invention relates to a vehicle or equipment battery charging devices that have a housing with a control panel, at least one charging port that can receive at least one cordless battery pack, an internal electric motor, a positive jumper cable and a negative jumper cable. During use, the at least one battery pack can be attached to the charging port such that the electric motor is powered and can charge a battery once the positive and negative jumper cables have been connected to the battery.

### CROSS-REFERENCE TO RELATED APPLICATION

The present application claims priority to, and the benefit of, U.S. Provisional Application No. 63/175,092, which was filed on Apr. 15, 2021 and is incorporated herein by reference in its entirety.

### FIELD OF THE INVENTION

The present invention relates generally to the field of battery assist or jump-start devices. More specifically, the present invention relates to a vehicle battery assist or jump-start device having a control panel, at least one charging port that can receive at least one cordless battery pack, an internal electric motor, a positive jumper cable and a negative jumper cable. In differing embodiments, the cordless battery pack may be a novel battery pack or any existing cordless battery pack known in the art, such as those used with power tools and other cordless devices. During use, the at least one battery pack can be attached to the charging port such that the electric motor is powered and can charge a vehicle battery once the positive and negative jumper cables have been connected to the battery. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

When a vehicle battery dies, one of the most common solutions involves jump-starting the dead vehicle battery via a jumper cable device known in the art. To successfully use the jumper cable, a second vehicle with a working battery in addition to the vehicle with the dead battery is required. However, in some instances an individual may be stranded with a vehicle with a dead battery in an area that is not near other vehicles which could be used to jump-start the dead battery using existing jumper cable devices. In addition, existing jumper cable devices may be too difficult for an individual to use, and may become tangled during storage and the cables can become frayed. Further, many individuals may own cordless power tools that utilize portable, rechargeable battery packs that often contain lithium-ion batteries. The batteries are typically lightweight and small enough that they can be easily stored and transported within a vehicle.

Therefore, there exists a long-felt need in the art for an improved jumper cable or battery-start assist device. There also exists a long-felt need in the art for a vehicle battery jump-start or assist device that does not require a second vehicle with a fully charged battery or other charged battery to be available in order to allow the device to charge the dead battery of a first vehicle. Further, there exists a long-felt need in the art for a vehicle battery jump-start or assist device that can be powered by one or more portable and common battery sources, such as cordless power tool battery packs.

The subject matter disclosed and claimed herein, in one embodiment thereof, comprises a vehicle battery jump-start or assist device. The device includes a control panel, with at least one charging port that can receive at least one cordless battery pack, an internal electric motor, a positive jumper cable, and a negative jumper cable. In differing embodiments, the cordless battery pack may be a novel battery pack or any existing cordless battery pack which is used for power tools or other cordless equipment. During use, the at least one battery pack can be attached to the charging port, such that the electric motor is powered and can charge a vehicle battery once the positive and negative jumper cables have been connected to the dead battery terminals.

In this manner, the vehicle battery jump-start or assist device of the present invention accomplishes all of the forgoing objectives and provides an improved jumper cable or battery start assist device that does not require a second vehicle with a fully charged battery or another car battery to be readily available in order to allow the assist device to charge the dead battery of a first vehicle. In addition, the vehicle battery jump-start or battery assist device can be powered by portable and common battery sources such as cordless power tool battery packs. In this manner, the device is extremely portable and can be used anywhere including, without limitation, remote locations without requiring a second nearby vehicle or other battery in the event that a first vehicle suffers from a dead battery.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle battery jump-start or battery assist device. The device can be used to easily jump-start or assist in starting a dead vehicle battery of a vehicle without the need to have an additional vehicle with a functioning battery or other charged battery to power the device. The primary components of the device include a control panel, at least one charging port that receives a cordless battery pack to provide power to the device, an internal electric motor, and positive and negative cables that contact the positive and negative terminals of a vehicle battery or other battery that needs charging such as a generator. The body of the device may further include a molded and/or foldable handle, in addition to a folding or removable hook, that allows the device to be secured within the interior engine bay of a vehicle so that it is readily available for use.

The control panel further includes a plurality of features such as a voltage or power meter, an on/off switch, a power selector, a charging status LED indicator, and a completed charging indicator. The voltage or power meter displays the power the device is outputting to a vehicle or other battery in need of a charge. The on/off switch allows a user to turn the device on/off, and the power selector allows the user to change the charging function or speed, e.g., from a trickle charge to a full charging feature, of the device via a plurality of modes. The charging status indicator further informs a user as to the charging status of the battery being charged and/or the battery status of the device's internal motor. Further, the completed charging indicator notifies a user when a vehicle battery has been fully charged or successfully jump-started after a user has successfully attached the positive and negative cables to the battery needing the charge.

Accordingly, the vehicle battery jump-start or battery assist device of the present invention is particularly advantageous as it allows a user to easily charge a dead battery, regardless of whether it is a vehicle battery, other equipment battery, e.g., generator, tractor, aircraft (fixed wing or rotary) or the like, without needing a second similar battery with a full charge to do so. In addition, the device is easily powered via convenient and portable cordless battery packs that are commonly used with cordless power tools. Finally, the device allows a user to freely travel without the worry of having a dead vehicle battery with no ability to charge the battery, as the device is small, convenient to use and portable.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle battery jump-start or battery assist device of the present invention in accordance with the disclosed structure, showing receptacles for two cordless battery packs;

FIG. 2 provides a perspective view of one potential embodiment of a vehicle battery jump-start or battery assist device of the present invention in accordance with the disclosed specification, wherein two cordless battery packs are attached to the receiving receptacles of the device;

FIG. 3 shows a perspective view of one potential embodiment of a vehicle battery jump-start or battery assist device of the present invention, in accordance with the disclosed structure, illustrating two cordless battery packs are attached to the device and the device is connected to a vehicle battery; and

FIG. 4 depicts a consumer kit for providing the invention in varying embodiments for consumer selection.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention, and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved jumper cable or battery assist device that allows a user to easily jump-start a dead battery such as a vehicle or other equipment battery. In addition, there is a long-felt need in the art for a battery jump-start or battery assist that does not require a second vehicle with a fully charged battery to be available in order to allow the device to charge the dead battery. Further, there exists a long-felt need in the art for a vehicle battery jump-start or battery assist device that can be powered by portable and common battery sources, such as cordless power tool battery packs.

The present invention, in one exemplary embodiment, is comprised of a vehicle battery jump-start or battery assist device that can be used to easily jump-start a dead battery of a vehicle or other equipment such as a generator, tractor or aircraft, without the need of a second battery from a vehicle or charging cart with a functioning and charged battery to power the first battery. The device includes a housing having a control panel, at least one charging port that receives a cordless battery pack that provides a source of energy for the device, an internal electric motor and positive and negative cables that contact and connect to the positive and negative terminals of a battery requiring charging. The body of the device may also have a molded and/or foldable handle as well as a folding or removable hook that allows the device to be secured within the interior engine bay of a vehicle. The device also includes a housing having the gauges, switches and receptacles.

The control panel is has a plurality of features including a voltage or power meter, an on/off switch, a power selector, a charging status LED indicator, and a charging indicator to indicate the status of the charge. The voltage or power meter displays the power the device is outputting to a battery being charged. The on/off switch allows a user to turn the device on or off, and the power selector allows the user to change the charging function or speed of the device to a plurality of different charging modes. The charging status indicator further informs the user on the charging status of the battery the device is charging, and/or the battery status of the device's internal motor for delivering a charge. Further, the completed charging indicator notifies a user when a battery has been fully charged or successfully ready to be jump-started after a user has successfully attached the positive and negative cables to the terminals of the battery.

As a result, the battery assist, charging or jump-start device of the present invention is particularly advantageous, as it allows a user to easily charge a dead battery of a vehicle or equipment without needing a second battery to be readily available with a charged battery. Further, the device is easily powered via convenient and portable cordless battery packs that are commonly used for cordless power tools and other household appliances or lawn care accessories, such as blowers, mowers and the like. In addition, the device allows a user to freely travel without the worry of having a dead battery with no convenient ability to charge the battery, as the device is small and portable.

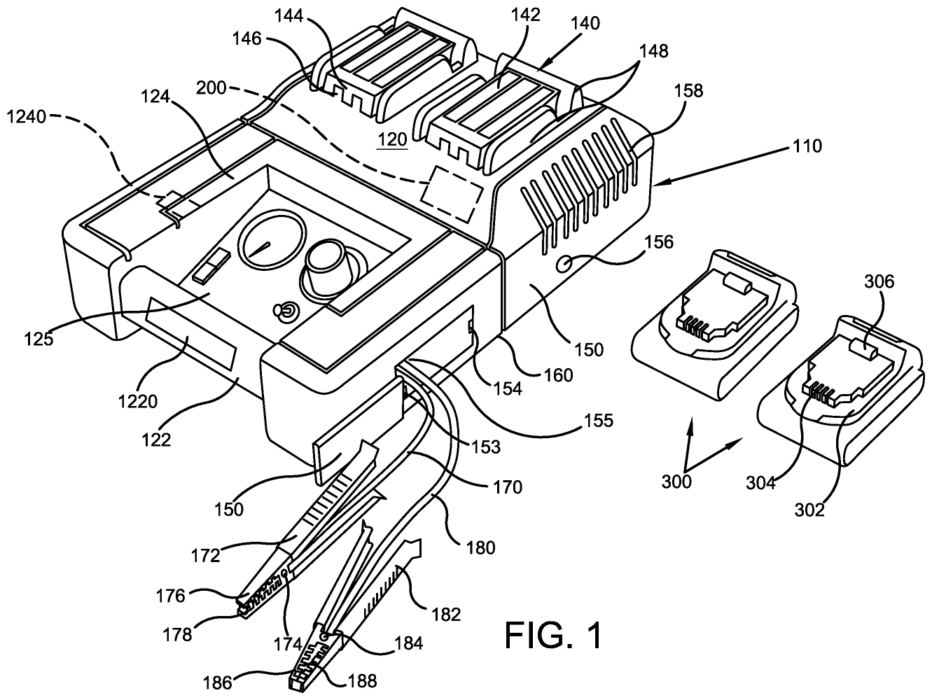

Referring initially to the drawings, FIG. 1 illustrates a perspective view of one potential embodiment of a battery charging, start assist or jump-start device 100 of the present invention in accordance with the disclosed structure, showing receptacles for two cordless battery packs 300 which are depicted attached to the device. The device 100 has a housing or body 110 that includes a control panel 125, at least one charging port 140 that receives at least one cordless battery pack 300, an internal electrical motor 200, a positive cable 170, and a negative cable 180. The body or housing 110 of the device 100 is preferably generally rectangular, but in differing embodiments may be any shape known in the art such as but not limited to rectangular, circular, triangular, oblong, etc. The body or housing 110 is also preferably made from a rigid, durable plastic such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. However, the body or housing 110 may also be constructed from durable metal, such as steel or aluminum, or other suitable material such as rubber.

The body or housing 110 has a top surface 120, two sets of generally parallel side surfaces 150, and a bottom surface 160. Any surface 120, 150, 160, of the body 110 may further include a molded, immovable handle 122 that may have a textured grip 1220 on any surface of the handle 122 that improves a user's ability to grip the handle 122. Additionally, or alternatively, any surface 120, 150, 160 may have a folding handle 124 that folds flush (e.g., in a recessed manner) with whichever surface 120, 150, 160 the handle 124 is located on when not in use. Further, the handle 124 preferably connects to a surface 120, 150, 160 via at least one hinge 1240. The hinge 1240 is of any hinge-type known in the art. Therefore, both handles 122, 124 allow the device 100 to be easily grabbed and maneuvered by a user as necessary. Further, any surface 120, 150, 160 of the body 110 or handle 122, 124 may have a plurality of indicia 126 such as but not limited to: words, phrases, a set of instructions, a set of safety warnings, logos, symbols, etc.

Any surface 120, 150, 160 of the body 110 may also have a control panel 125 that houses a plurality of features that include but are not limited to: a voltage or power meter 127, an on/off switch 128, a power selector 129, a charging status LED indicator 130 and a charging status indicator 131 to show charging progress. In differing embodiments, the voltage or power meter 127 may have a needle-style or digital number style indicator that displays the power the device 100 is outputting to a battery 10 in volts, amps or any other electrical or power unit of the like. The power to the motor 200 of the device 100 can be controlled via the on/off switch 128, and a power selector 129 button allows a user to cycle through a plurality of charging modes such as but not limited to: quick/rapid charge, normal charge, slow charge, battery drip or trickle charge, etc. Further, the charging status of the battery 10 the device 100 is attached to or the battery status of the motor 200 may be displayed via a charging status LED indicator 130. The indicator 130 may display the charging status in terms of a percentage or a number of illuminated LED's where each LED would represent a percent of charge (e.g.., each LED represents every twenty-five percent (25%) charged). Further, the indicator 130 may also alert a user when the battery 10 has been fully charged by the device 100 by illuminating the completed charge status in a specific color, for example green. Finally, a charging cycle 131 button allows a user to select one of a number of pre-programmed timed charging cycles, and the device 100 will automatically stop charging a battery 10 after the cycle has concluded.

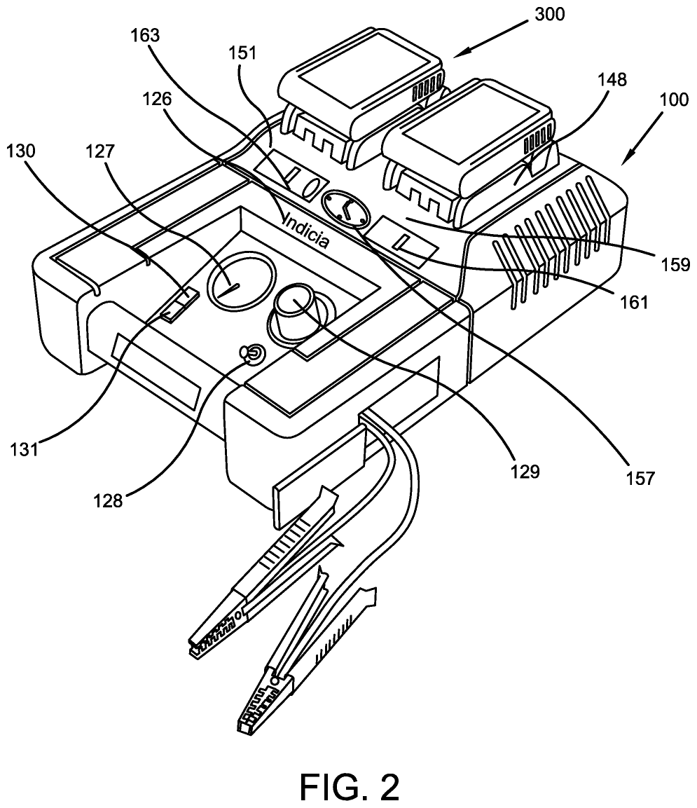

The top surface 120 (or in differing embodiments, any surface 120, 150, 160) also has at least one charging port 140, and the top surface 142 and/or side surfaces 144 of the charging port 140 includes at least one groove 146. As best seen in FIG. 2, which illustrates a perspective view of one potential embodiment of a vehicle battery charging, assist or jump-start device 100 of the present invention showing two cordless battery packs 300 attached to the device 100, the groove 146 engages groove 304 of a cordless battery pack 300, and the groove 304 is located on the bottom surface 302 of the battery pack 300. The battery pack 300 may also include a locking tab 306 that can be depressed to release the battery pack 300 from the charging port 140 as needed. Further, the charging port 140 may have a plurality of protective sidewalls 148 that help retain and protect the battery pack 300 once the pack 300 has engaged the charging port 140. It is further contemplated that the device 100 may be provided in a kit that contains both the device 100 and at least one cordless battery pack 300. In a kit configuration, the battery charging device can include the battery pack 300 can along with cordless power tools or other consumer accessories. However, the device 100 may also still accept and is compatible with other cordless battery packs known in the art that may be used by cordless power tools and other consumer accessories, such as mowers, blowers, vacuums, and the like.

Further, any surface 120, 150, 160 of the body 110 may have a removable cover plate 152 that has a tab 153 which engages a groove 154 located in the interior 155 of the body 110, such that when the tab 153 is depressed the cover plate 152 can be removed from the body 110 to allow access to the interior 155 of the device 100 where the cables 170, 180 are stored. Any surface 120, 150, 160 of the body 110 may also have a plurality of LED lights 156 which aid in illuminating the area around the device 100 during use (e.g. when the device 100 is being used in the engine area of a vehicle). The device 100 may also have a removable or folding hook 190, that can be stored in a folded state within the body 110 when not in use and can be used to hook the device 100 onto various surfaces within a vehicle engine bay or hood. FIG. 2 also shows separate battery indicators 151 and 161 which may allow a user to turn on or off the individual batteries by a switch 159. The indicators 151 and 161 may also have a sensor 163 to show the temperature of the battery pack 300 or other conditions of the battery pack 300. A clock 157 may also be provided to show the time left of the charge, or alternatively the amount of time since the charging has started.

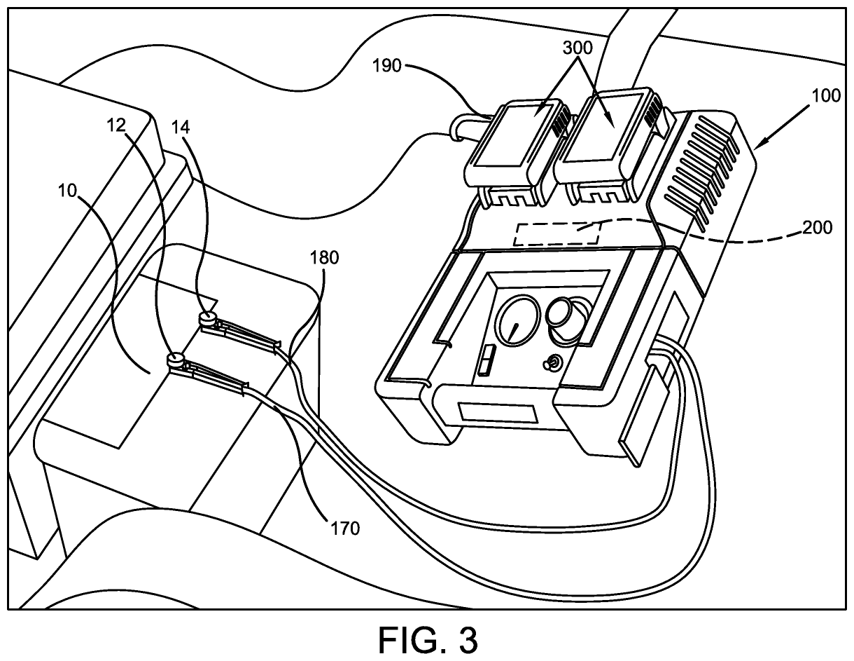

As noted in FIG. 3, the device has a motor 200 (that may alternatively be in the form of a generator) that receives power from and can be charged by the cordless battery pack 300. A positive cable 170 and a negative cable 180 are further in electrical communication with the motor 200 such that each cable 170, 180 receives power from the motor 200 in the form of electricity, and each cable 170, 180 may be retractably stored within the body 110 when not in use. Each cable 170, 180 further includes a rubber, non-conductive grip 172, 182 and a pair of metal jaws 176, 186 connected to one another via a hinge 174, 184, such that the jaws 176, 186 can be opened/closed by squeezing or letting go off the grip 172, 182. The jaws 176, 186 may have a plurality of protrusions 178, 188 that aid each set of jaws 176, 186 in grabbing the positive terminal 12, and negative terminal 14 of a vehicle battery 10, as seen in FIG. 3. As seen in FIG. 3 the invention may be secured under the hood area of a vehicle engine compartment. In this manner, the battery charging device is always conveniently available, and may be used by inserting one or more battery back to assist in the charging of the vehicle or other equipment.

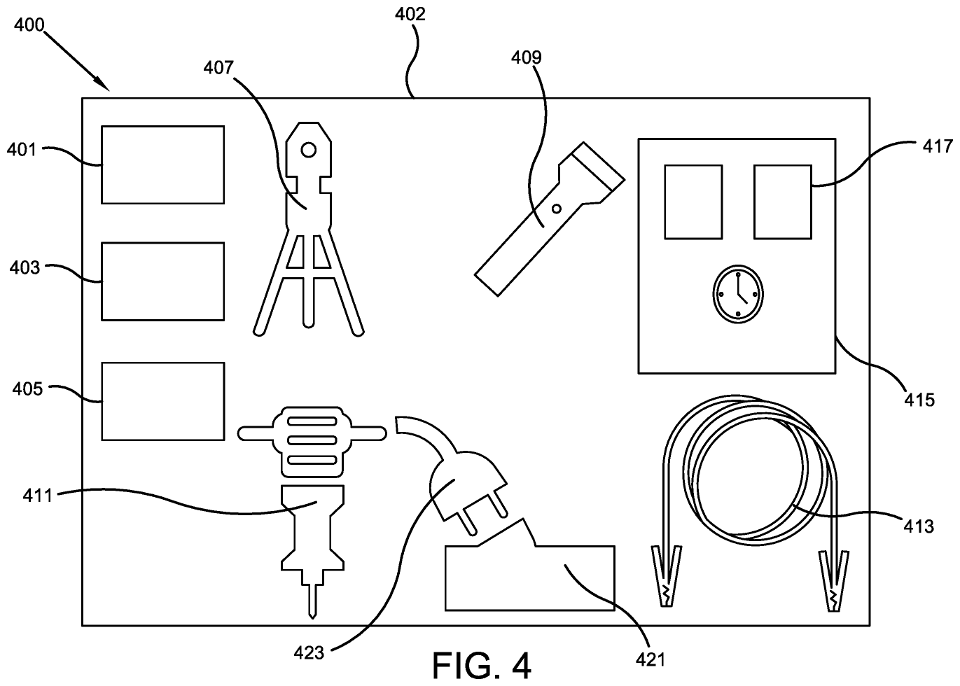

FIG. 4 shows a kit 400 having a number of different components for providing the present invention. The kit 400 includes a package 402 which is configured for retail and/or online sales. The kit 400 includes rechargeable battery packs 401, 403 and 405. The kit may include different consumer accessories, such as a camera 407, flashlight 409 and drill 411, depending on the preferred selection of accessories sought by the particular consumer. The kit 400 also includes the battery charger 415 having a plurality of receptacles 417 to receive individual battery packs. The kit also includes cables 413 to connect the battery charging pack to a battery to be charged. The kit may also include a charging station 421 for separately charging the battery packs such as by an electric cord 423 which may be plugged into a traditional electric outlet.

In one embodiment, the battery pack and device may be reversible such that if there is no electricity on a job site, a vehicle battery can still be used to charge the battery packs. Additionally, the battery packs should be or a high or superior quality to provide longer life than a jump pack. The jump-start device can be used with a variety of engines including those associated with vehicles, tractors, equipment and the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle battery jump-start device” and “device” are interchangeable and refer to the consumption tracking wine glass 100 of the present invention.

Notwithstanding the forgoing, the vehicle battery jump-start device 100 of the present invention and its various components can be of any suitable size and configuration as is known in the art without affecting the overall concept of the invention, provided that they accomplish the above-stated objectives. One of ordinary skill in the art will appreciate that the size, configuration and material of the vehicle battery jump-start device 100 as shown in the FIGS. are for illustrative purposes only, and that many other sizes and shapes of the vehicle battery jump-start device 100 are well within the scope of the present disclosure. Although the dimensions of the vehicle battery jump-start device 100 are important design parameters for user convenience, the vehicle battery jump-start device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A battery charging device comprising:
a body;
a control panel disposed on a surface of the body;
a first charging port;
a positive jumper cable;
a negative jumper cable; and
at least one cordless battery pack comprising a locking feature to allow the at least one cordless battery pack to be removably secured to the first charging port.

2. The battery charging device as recited in claim 1 further comprising an electric motor, wherein each of the negative and positive jumper cables are connected to the electric motor, and further wherein the control panel comprises a voltage or power meter, an on/off switch, a power selector button, a charging status LED indicator, and a charging cycle button.

3. The battery charging device as recited in claim 2, wherein the control panel further comprises a clock for measuring a charging time.

4. The battery charging device as recited in claim 1, wherein the first charging port comprises a switch for activating the first charging port and using power from the at least one cordless battery pack.

5. The battery charging device as recited in claim 4, wherein the first charging port further comprises a sensor to detect a temperature of the at least one cordless battery pack.

6. The battery charging device as recited in claim 1, wherein each of the positive and negative jumper cables is retractable within the body of the charging device.

7. The battery charging device as recited in claim 6, wherein each of the positive and negative jumper cables includes a clamp on an end for connection to a terminal on a battery for charging the battery.

8. The battery charging device as recited in claim 1 further comprising a second charging port and a pair of cordless battery packs.

9. The battery charging device as recited in claim 2, wherein the LED charging indicator provides an indication of a completion of a charging session.

10. The battery charging device as recited in claim 1, wherein the body comprises a handle.

11. A portable battery charger comprising:
a housing having a handle, a control panel, a first battery receptacle and a second battery receptacle integrated with a surface of the handle;
a first and a second cordless battery removably connected to the first and second battery receptacles, respectively; and
the control panel having a plurality of controls and indicators or initiating a charging cycle and for indicating a completion of the charging cycle, wherein the charging cycle can be one of a rapid charging mode, a normal charging mode, a slow charging mode, or a battery drip or trickle charging mode.

12. The portable battery charger as recited in claim 11, wherein the plurality of controls and indicators comprise at least one LED light to indicate the completion of the charging cycle.

13. The portable battery charger as recited in claim 11, wherein each of the first and second battery receptacles comprises a switch to activate the first and second battery receptacles.

14. The portable battery charger as recited in claim 13, wherein each of the first and second battery receptacles switches comprise a sensor that senses a condition of the cordless battery pack within the receptacle.

15. The portable battery charger as recited in claim 11 further comprising a clock disposed on the housing for showing a status of the charging cycle.

16. The portable battery charger as recited in claim 11, wherein the control panel further comprises a voltage or power meter, an on/off switch and a power selector button.

17. The portable battery charger as recited in claim 16, wherein the voltage or power meter is a needle-style indicator that displays a power output to a battery in volts or amps.

18. A battery charging kit comprising:
a package configured for one of a retail or on-line sale;
a plurality of cordless battery packs;
a battery charger comprising a plurality of battery receptacles for receiving the plurality of cordless battery packs, wherein the battery charger further comprises a control panel that includes at least one of a voltage or power meter, an on/off switch and a power selector button; and
at least one other consumer accessory for use with at least one of the plurality of cordless battery packs.

19. The battery charging kit as recited in claim 18, wherein the at least one other consumer accessory comprises a camera, a drill or a flashlight.

20. The battery charging kit as recited in claim 19 further comprising a charging station for recharging the plurality of cordless battery packs.
